(19) United States
(12) Patent Application Publication
(10) Pub. No.: US 2026/0225780 A1
(43) Pub. Date: Aug. 6, 2026

(54) Water-Proof and Oil-Proof Coating, Preparation Method and Use Thereof

(71) Applicant: South China University of Technology, Guangzhou, Guangdong (CN)

(72) Inventors: Xiaohui WANG, Guangzhou, Guangdong (CN); Yunfeng ZHOU, Guangzhou, Guangdong (CN); Qingying HUANG, Guangzhou, Guangdong (CN); Hao LING, Guangzhou, Guangdong (CN); Quanbo HUANG, Guangzhou, Guangdong (CN)

(73) Assignee: South China University of Technology, Guangzhou, Guangdong (CN)

(21) Appl. No.: 19/128,565

(22) PCT Filed: Oct. 26, 2023
(86) PCT No.: PCT/CN2023/126805

§ 371 Date: May 9, 2025

(30) Foreign Application Priority Data
Dec. 28, 2022 (CN) 202211696092.2

(51) Int. Cl. B65D 65/42; C09D 7/20; C09D 7/40; C09D 7/63; C09D 7/65; C09D 101/02; D21H 19/12

(52) U.S. Cl. CPC B65D 65/42; C09D 7/20; C09D 7/63; C09D 7/65; C09D 7/67; C09D 101/02; D21H 19/12; D10B 2401/02; D10B 2505/10

(57) ABSTRACT

The invention discloses a waterproof and oil-proof coating as well as a preparation method and application thereof. The waterproof and oil-proof coating comprises the following components in percentage by mass: 10%-20% of a citrus peel extracting solution; 1%-2% of bacterial cellulose; 1%-2% of nano calcium carbonate; 3%-6% of glycerol; 3%-5% of a food-grade thickening agent; 0.2%-0.6% of a food grade defoaming agent; 0.5%-1% of a food-grade emulsifier; and the balance of water. The preparation method of the waterproof and oil-proof coating comprises the following step: uniformly mixing the citrus peel extracting solution, the bacterial cellulose, the nano calcium carbonate, the glycerol, the food-grade thickening agent, the food-grade defoaming agent, the food-grade emulsifying agent and the water to obtain the waterproof and oil-proof coating. The waterproof and oil-proof coating can endow a paper-based material with excellent waterproof and oil-proof performance, and is degradable, simple in preparation process, low in production cost and suitable for large-scale industrial application.

### TECHNICAL FIELD

The present disclosure relates to the technical field of coatings, in particular to a water-proof and oil-proof coating, a preparation method and use thereof.

### BACKGROUND

In recent years, the “take-out” food industry has developed rapidly, which has brought great convenience to the lives of people but has also produced a large amount of plastic waste. In nature, plastic waste will eventually be transformed into extremely small-sized microplastics, and the microplastics will cause serious damage to the survival of animals and plants.

At present, many enterprises begin to use paper-based materials such as PE (polyethylene)-coated paper and PLA (polylactic acid)-coated paper to replace traditional plastic materials, so as to reduce the adverse impact on the environment. However, for PE-coated paper, it is still necessary to use non-degradable PE, which does not fundamentally solve the environmental pollution problem caused by plastic waste. For PLA-coated paper, although degradable polylactic acid (PLA) is used, PLA can only degrade in a specific ideal environment and will still cause the same harm as non-degradable plastics if it is not fully recycled. In addition, in order to improve the water-proof and oil-proof performance of food packaging paper-based materials, many enterprises also use expensive fluorine-containing compounds, which have biological safety hazards and may induce cancer. In summary, the existing food packaging paper-based materials all have difficulty fully meeting the practical application requirements.

Therefore, it is of great significance to develop a degradable coating for food packaging with an excellent water-proof and oil-proof performance.

### SUMMARY

The object of the present disclosure is to provide a water-proof and oil-proof coating, a preparation method and use thereof.

The technical solution used by the present disclosure is as follows:
A water-proof and oil-proof coating comprises the following components by mass percent:
10% to 20% of a citrus peel extraction solution;
1% to 2% of bacterial cellulose;
10% to 2% of nano calcium carbonate;
3% to 6% of glycerol;
3% to 5% of a food-grade thickener;
0.2% to 0.6% of a food-grade defoamer;
0.5% to 1% of a food-grade emulsifier; and
the balance being water.

Preferably, the citrus peel extraction solution is prepared by a preparation method comprising the following steps:
1) drying, then crushing, and sieving citrus peel to obtain citrus peel powder; and
2) adding the citrus peel powder to a sodium hypochlorite solution to obtain a mixture, then adjusting a pH value of the mixture to 3-4, then stirring the mixture at a constant temperature of 50° C. to 60° C., then performing an ultrasonic treatment and standing, and collecting a supernatant to obtain the citrus peel extraction solution.

Preferably, the citrus peel in step 1) is selected from at least one of orange peel and grapefruit peel. The mesocarp of citrus fruits is tangerine pith and the endocarp is juice sacs. These two peels mainly contain pectin, flavonoids, vitamins, cellulose, limonoids, etc., wherein the content of pectin is about 4% of the fresh peel or about 20% of the dry peel. The naturally occurring protopectin in the peel is a water-insoluble molecule, which is closely combined with cellulose to constitute an intermediate layer adhesive between adjacent cells, so that cellulose fibers are tightly bonded together. Rich cellulose fibers and pectin can form a stable network structure by means of the adhesive action of pectin, which has good film-forming property. In addition, carboxyl groups exposed on pectin and hydroxyl groups on cellulose can undergo an esterification reaction to eliminate hydrophilic groups, thus improving the waterproof ability of a material, so that the problem that existing natural materials cannot be both water-proof and oil-proof can be solved.

Preferably, the citrus peel in step 1) is the outer skin of citrus fruits with regular fruit shape, no deformity, bright and clean pulp, and fresh fruit stalks.

Preferably, the drying in step 1) is carried out at 50° C. to 60° C. for a drying time of 40 min to 50 min.

Preferably, the sieving in step 1) is performed with a 50-mesh sieve.

Preferably, the ultrasonic treatment in step 2) has an ultrasonic power of 200 W to 300 W and a treatment time of 10 min to 20 min.

Preferably, the bacterial cellulose has a degree of polymerization of 2000 to 4000.

Preferably, the bacterial cellulose is subjected to sterilization, impurity removal, and decoloration treatments.

Preferably, the nano calcium carbonate has a particle size of 10 nm to 20 nm.

Preferably, the food-grade thickener is selected from at least one of xanthan gum, swim bladder gel, and acid-processed gelatin.

Preferably, the food-grade defoamer is selected from at least one of stearyl stearate, polydimethylsiloxane, and sorbitan fatty acid ester.

Preferably, the food-grade emulsifier is selected from at least one of sodium dodecyl sulfate (SDS), polysorbate-80 (Tween-80), and sorbitan palmitate (Span-40).

A method for preparing the water-proof and oil-proof coating as described above, comprises the following step: uniformly mixing a citrus peel extraction solution, bacterial cellulose, nano calcium carbonate, glycerol, a food-grade thickener, a food-grade defoamer, a food-grade emulsifier, and water to obtain the water-proof and oil-proof coating.

Preferably, the uniform mixing is carried out under the condition of a rotation speed of a stirrer of 10000 r/min to 14000 r/min, and the stirring time is 10 min to 15 min.

A paper-based material, the surface of which is coated with the above water-proof and oil-proof coating.

A food package comprises the above paper-based material.

Beneficial Effects of the Invention: the water-proof and oil-proof coating of the present disclosure can endow a paper-based material with excellent water-proof and oil-proof performances, is degradable, simple in preparation process and low in production cost, and is suitable for large-scale industrial application.

Specifically:
1) All the raw materials used for the water-proof and oil-proof coating of the present disclosure are natural degradable materials, which fundamentally solves the problems of white pollution and plastic harm easily caused by PE-coated paper and PLA-coated paper.
2) All the raw materials used for the water-proof and oil-proof coating are food-grade raw materials, which are suitable for food packaging contact paper, can reach the oil-proof and water-proof standards of the existing food packaging paper on the market, are more environmentally friendly and healthy, and can be recycled.
3) The water-proof and oil-proof coating of the present disclosure is an aqueous solution, which has no organic solvent pollution during the preparation process, is simple in operation process and low in raw material cost, and has good industrial prospect.
4) All the raw materials used for the water-proof and oil-proof coating of the present disclosure have good water dispersibility. Pectin and cellulose in the citrus peel extraction solution can expose rich carboxyl and hydroxyl groups in the aqueous solution and form a relatively dense network structure by means of hydrogen bonding and hydrophobic interaction. It can be closely combined with paper-based materials. Citrus peel also contains a large amount of essential oils, which have bactericidal effect and can make the coating have good and lasting antibacterial and antiseptic effects. By adding the food-grade thickener, the film-forming performance of the coating can be improved. By adding the nano calcium carbonate, the surface of the paper base can be filled to form a dense thin film, endowing the paper with a good oil-proof and water-proof performance (oil-proof grade kit >6, and the cobb value of water-proof performance can reach 6.7 g/m² to 8.2 g/m²).

### BRIEF DESCRIPTION OF THE DRAWINGS

FIG. 1 is an SEM image of food-grade white paper of Example 1.

FIG. 2 is an SEM image of the coated paper of Example 1.

FIG. 3 is a diagram showing the water-proof and oil-proof effect of the coated paper of Example 1, wherein water is on the left and edible oil is on the right.

### DETAILED DESCRIPTION

The present disclosure will be further explained and illustrated with reference to specific examples.

### Example 1

A water-proof and oil-proof coating, the components of which were as shown in the following table:

TABLE 1
Components of water-proof and oil-proof coating

| Components | Mass percent (%) |
|---|---|
| Citrus peel extraction solution | 20 |
| Bacterial cellulose (with a degree of | 2 |
| polymerization of 2000-4000, which | |
| had undergone sterilization, impurity | |
| removal, and decoloration treatments) | |
| Nano calcium carbonate (with a | 2 |
| particle size of 10-20 nm) | |
| Glycerol | 6 |
| Xanthan gum | 5 |
| Stearyl stearate | 0.6 |
| Sodium dodecyl sulfate | 1 |
| Deionized water | 63.4 |

A method for preparing the above water-proof and oil-proof coating comprised the following steps:
1) 120 g of fresh orange peel (orange peel with regular fruit shape, no deformity, bright and clean pulp, and fresh fruit stalks) was put into an oven, dried at 60° C. for 40 min, crushed, and sieved through a 50-mesh sieve to obtain 28 g of citrus peel powder;
2) the citrus peel powder was added to 300 mL of a sodium hypochlorite solution with a mass fraction of 10%, a citric acid solution with a mass fraction of 10% was then added to adjust the pH value to 3-4, the mixture was then stirred at a constant temperature of 55° C., then subjected to a 200 W ultrasonic treatment for 15 min, and left to stand for 30 min, and a supernatant was collected to obtain 20 g of a citrus peel extraction solution; and
3) the citrus peel extraction solution, bacterial cellulose, nano calcium carbonate, glycerol, xanthan gum, stearyl stearate, sodium dodecyl sulfate, and deionized water were mixed, and the mixture was stirred for 10 min at a rotation speed of a stirrer of 10000 r/min, thus obtaining the water-proof and oil-proof coating.

A method for preparing a coated paper comprised the following steps:
coating 38 g/m² food-grade white paper with the water-proof and oil-proof coating of this example by using a RDS40 coating rod, with a coating amount of 7.8 g/m², and then placing the paper in an oven for drying at 70° C. for 5 min and then at 120° C. for 2 min to obtain the coated paper.

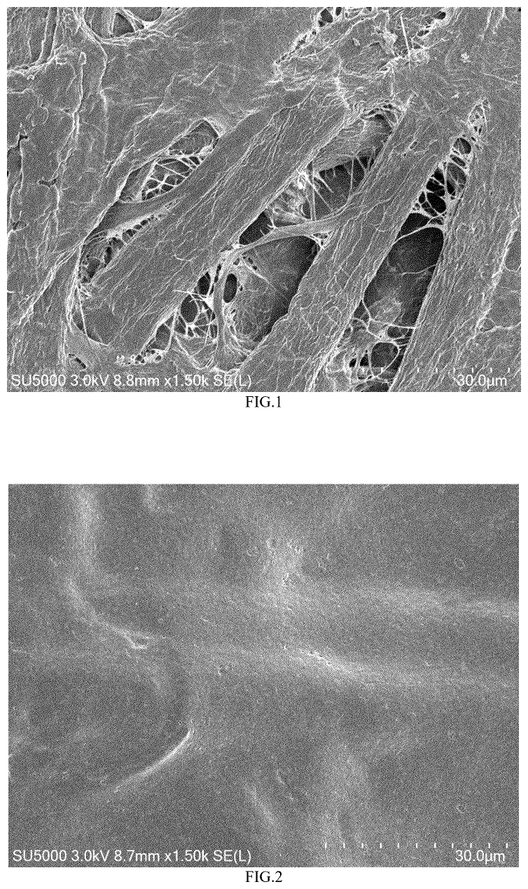

Performance test:
1) A scanning electron microscope (SEM) image of the food-grade white paper of this example was as shown in FIG. 1, and an SEM image of the coated paper was as shown in FIG. 2.

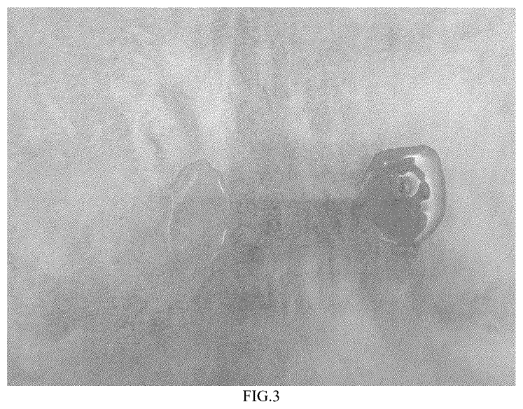

As can be seen from FIG. 1 and FIG. 2, the water-proof and oil-proof coating was formed as a layer of dense barrier thin film with a smooth surface on the surface of the food-grade white paper, and the barrier thin film completely covered the original holes in fibers in the food-grade white paper and achieved oil-proof and water-proof effects.
2) The oil-proof performance of the coated paper of this example was measured. The oil-proof grade kit was measured to be >7. Then, 120° C. edible oil was poured on the coated paper evenly. There was no seepage spot on the surface of the sample, and the oil-proof performance was good. Then, the water-proof performance of the coated paper was measured, and the cobb60 value was 8.2 g/m². The coated paper was able to withstand 95° C. hot water (the water-proof and oil-proof effect diagram was as shown in FIG. 3, in which water was on the left and edible oil was on the right).

### Example 2

A water-proof and oil-proof coating, the components of which were as shown in the following table:

TABLE 2
Components of water-proof and oil-proof coating

| Components | Mass percent (%) |
|---|---|
| Citrus peel extraction solution | 10 |
| Bacterial cellulose (with a degree of | 1 |
| polymerization of 2000-4000, which | |
| had undergone sterilization, impurity | |
| removal, and decoloration treatments) | |
| Nano calcium carbonate (with a | 1 |
| particle size of 10-20 nm) | |
| Glycerol | 3 |
| Xanthan gum | 3 |
| Stearyl stearate | 0.2 |
| Sodium dodecyl sulfate | 0.5 |
| Deionized water | 81.3 |

A method for preparing the above water-proof and oil-proof coating comprised the following steps:
1) 90 g of fresh orange peel (orange peel with regular fruit shape, no deformity, bright and clean pulp, and fresh fruit stalks) was put into an oven, dried at 60° C. for 40 min, crushed, and sieved through a 50-mesh sieve to obtain 15 g of citrus peel powder;
2) the citrus peel powder was added to 120 mL of a sodium hypochlorite solution with a mass fraction of 10%, a citric acid solution with a mass fraction of 10% was then added to adjust the pH value to 3-4, the mixture was then stirred at a constant temperature of 55° C., then subjected to a 200 W ultrasonic treatment for 15 min, and left to stand for 30 min, and a supernatant was collected to obtain 10 g of a citrus peel extraction solution; and
3) the citrus peel extraction solution, bacterial cellulose, nano calcium carbonate, glycerol, xanthan gum, stearyl stearate, sodium dodecyl sulfate, and deionized water were mixed, and the mixture was stirred for 10 min at a rotation speed of a stirrer of 10000 r/min, thus obtaining the water-proof and oil-proof coating.

A method for preparing a coated paper comprised the following steps:
coating 38 g/m² food-grade white paper with the water-proof and oil-proof coating of this example by using a RDS50 coating rod, with a coating amount of 5.3 g/m², and then placing the paper in an oven for drying at 70° C. for 5 min and then at 120° C. for 2 min to obtain the coated paper.

### Performance Test:

The oil-proof performance of the coated paper of this example was measured. The oil-proof grade kit was measured to be >7. Then, 120° C. edible oil was poured on the coated paper evenly. There was no seepage spot on the surface of the sample, and the oil-proof performance was good. Then, the water-proof performance of the coated paper was measured, and the cobb60 value was 6.7 g/m². The coated paper was able to withstand 95° C. hot water.

### Example 3

A water-proof and oil-proof coating, the components of which were as shown in the following table:

TABLE 3
Components of water-proof and oil-proof coating

| Components | Mass percent (%) |
|---|---|
| Citrus peel extraction solution | 15 |
| Bacterial cellulose (with a degree of | 1 |
| polymerization of 2000-4000, which | |
| had undergone sterilization, impurity | |
| removal, and decoloration treatments) | |
| Nano calcium carbonate (with a | 1 |
| particle size of 10-20 nm) | |
| Glycerol | 3 |
| Swim bladder gel | 3 |
| Sorbitan fatty acid ester | 0.2 |
| Tween-80 | 0.5 |
| Deionized water | 76.3 |

A method for preparing the above water-proof and oil-proof coating comprised the following steps:
1) 100 g of fresh orange peel (orange peel with regular fruit shape, no deformity, bright and clean pulp, and fresh fruit stalks) was put into an oven, dried at 60° C. for 40 min, crushed, and sieved through a 50-mesh sieve to obtain 18 g of citrus peel powder;
2) the citrus peel powder was added to 200 mL of a sodium hypochlorite solution with a mass fraction of 10%, a citric acid solution with a mass fraction of 10% was then added to adjust the pH value to 3-4, the mixture was then stirred at a constant temperature of 55° C., then subjected to a 200 W ultrasonic treatment for 15 min, and left to stand for 30 min, and a supernatant was collected to obtain 15 g of a citrus peel extraction solution; and
3) the citrus peel extraction solution, bacterial cellulose, nano calcium carbonate, glycerol, swim bladder gel, sorbitan fatty acid ester, Tween-80, and deionized water were mixed, and the mixture was stirred for 10 min at a rotation speed of a stirrer of 10000 r/min, thus obtaining the water-proof and oil-proof coating.

A method for preparing a coated paper comprised the following steps:
coating 38 g/m² food-grade white paper with the water-proof and oil-proof coating of this example by using a RDS50 coating rod, with a coating amount of 6.2 g/m², and then placing the paper in an oven for drying at 60° C. for 10 min and then at 120° C. for 2 min to obtain the coated paper.

### Performance Test:

The oil-proof performance of the coated paper of this example was measured. The oil-proof grade kit was measured to be >6. Then, 120° C. edible oil was poured on the coated paper evenly. There was no seepage spot on the surface of the sample, and the oil-proof performance was good. Then, the water-proof performance of the coated paper was measured, and the cobb60 value was 7.8 g/m². The coated paper was able to withstand 95° C. hot water.

### Example 4

A water-proof and oil-proof coating, the components of which were as shown in the following table:

TABLE 4
Components of water-proof and oil-proof coating

| Components | Mass percent (%) |
|---|---|
| Citrus peel extraction solution | 20 |
| Bacterial cellulose (with a degree of | 2 |
| polymerization of 2000-4000, which | |
| had undergone sterilization, impurity | |
| removal, and decoloration treatments) | |
| Nano calcium carbonate (with a | 2 |
| particle size of 10-20 nm) | |
| Glycerol | 6 |
| Acid-processed gelatin | 5 |
| Stearyl stearate | 0.6 |
| Sodium dodecyl sulfate | 1 |
| Deionized water | 63.4 |

A method for preparing the above water-proof and oil-proof coating comprised the following steps:
1) 120 g of fresh grapefruit peel (grapefruit peel with regular fruit shape, no deformity, bright and clean pulp, and fresh fruit stalks) was put into an oven, dried at 60° C. for 40 min, crushed, and sieved through a 50-mesh sieve to obtain 28 g of citrus peel powder;
2) the citrus peel powder was added to 300 mL of a sodium hypochlorite solution with a mass fraction of 10%, a citric acid solution with a mass fraction of 10% was then added to adjust the pH value to 3-4, the mixture was then stirred at a constant temperature of 55° C., then subjected to a 200 W ultrasonic treatment for 15 min, and left to stand for 30 min, and a supernatant was collected to obtain 20 g of a citrus peel extraction solution; and
3) the citrus peel extraction solution, bacterial cellulose, nano calcium carbonate, glycerol, acid-processed gelatin, stearyl stearate, sodium dodecyl sulfate, and deionized water were mixed, and the mixture was stirred for 10 min at a rotation speed of a stirrer of 10000 r/min, thus obtaining the water-proof and oil-proof coating.

A method for preparing a coated paper comprised the following steps:
coating 38 g/m² food-grade white paper with the water-proof and oil-proof coating of this example by using a RDS40 coating rod, with a coating amount of 6.3 g/m², and then placing the paper in an oven for drying at 70° C. for 5 min and then at 120° C. for 2 min to obtain the coated paper.

### Performance Test:

The oil-proof performance of the coated paper of this example was measured. The oil-proof grade kit was measured to be >6. Then, 120° C. edible oil was poured on the coated paper evenly. There was no seepage spot on the surface of the sample, and the oil-proof performance was good. Then, the water-proof performance of the coated paper was measured, and the cobb60 value was 7.9 g/m². The coated paper was able to withstand 95° C. hot water.

### Example 5

A water-proof and oil-proof coating, the components of which were as shown in the following table:

TABLE 5
Components of water-proof and oil-proof coating

| Components | Mass percent (%) |
|---|---|
| Citrus peel extraction solution | 20 |
| Bacterial cellulose (with a degree of | 2 |
| polymerization of 2000-4000, which | |
| had undergone sterilization, impurity | |
| removal, and decoloration treatments) | |
| Nano calcium carbonate (with a | 2 |
| particle size of 10-20 nm) | |
| Glycerol | 6 |
| Swim bladder gel | 5 |
| Sorbitan fatty acid ester | 0.6 |
| Tween-80 | 1 |
| Deionized water | 63.4 |

A method for preparing the above water-proof and oil-proof coating comprised the following steps:
1) 120 g of fresh grapefruit peel (grapefruit peel with regular fruit shape, no deformity, bright and clean pulp, and fresh fruit stalks) was put into an oven, dried at 60° C. for 40 min, crushed, and sieved through a 50-mesh sieve to obtain 28 g of citrus peel powder;
2) the citrus peel powder was added to 300 mL of a sodium hypochlorite solution with a mass fraction of 10%, a citric acid solution with a mass fraction of 10% was then added to adjust the pH value to 3-4, the mixture was then stirred at a constant temperature of 55° C., then subjected to a 200 W ultrasonic treatment for 15 min, and left to stand for 30 min, and a supernatant was collected to obtain 20 g of a citrus peel extraction solution; and
3) the citrus peel extraction solution, bacterial cellulose, nano calcium carbonate, glycerol, swim bladder gel, sorbitan fatty acid ester, Tween-80, and deionized water were mixed, and the mixture was stirred for 10 min at a rotation speed of a stirrer of 10000 r/min, thus obtaining the water-proof and oil-proof coating.

A method for preparing a coated paper comprised the following steps:
coating 38 g/m² food-grade white paper with the water-proof and oil-proof coating of this example by using a RDS40 coating rod, with a coating amount of 6.1 g/m², and then placing the paper in an oven for drying at 60° C. for 10 min and then at 120° C. for 2 min to obtain the coated paper.

### Performance Test:

The oil-proof performance of the coated paper of this example was measured. The oil-proof grade kit was measured to be >6. Then, 120° C. edible oil was poured on the coated paper evenly. There was no seepage spot on the surface of the sample, and the oil-proof performance was good. Then, the water-proof performance of the coated paper was measured, and the cobb60 value was 8.1 g/m². The coated paper was able to withstand 95° C. hot water.

### Example 6

A water-proof and oil-proof coating, the components of which were as shown in the following table:

TABLE 6
Components of a water-proof and oil-proof coating

| Components | Mass percent (%) |
|---|---|
| Citrus peel extraction solution | 15 |
| Bacterial cellulose (with a degree of | 1.5 |
| polymerization of 2000-4000, which | |
| had undergone sterilization, impurity | |
| removal, and decoloration treatments) | |
| Nano calcium carbonate (with a | 1.5 |
| particle size of 10-20 nm) | |
| Glycerol | 5 |
| Xanthan gum | 4 |
| Stearyl stearate | 0.4 |
| Sodium dodecyl sulfate | 0.8 |
| Deionized water | 71.8 |

A method for preparing the above water-proof and oil-proof coating comprised the following steps:
1) 100 g of fresh grapefruit peel (grapefruit peel with regular fruit shape, no deformity, bright and clean pulp, and fresh fruit stalks) was put into an oven, dried at 60° C. for 40 min, crushed, and sieved through a 50-mesh sieve to obtain 18 g of citrus peel powder;
2) the citrus peel powder was added to 200 mL of a sodium hypochlorite solution with a mass fraction of 10%, a citric acid solution with a mass fraction of 10% was then added to adjust the pH value to 3-4, the mixture was then stirred at a constant temperature of 55° C., then subjected to a 200 W ultrasonic treatment for 15 min, and left to stand for 30 min, and a supernatant was collected to obtain 15 g of a citrus peel extraction solution; and
3) the citrus peel extraction solution, bacterial cellulose, nano calcium carbonate, glycerol, xanthan gum, stearyl stearate, sodium dodecyl sulfate, and deionized water were mixed, and the mixture was stirred for 10 min at a rotation speed of a stirrer of 10000 r/min, thus obtaining the water-proof and oil-proof coating.

A method for preparing a coated paper comprised the following steps:
coating 38 g/m² food-grade white paper with the water-proof and oil-proof coating of this example by using a RDS50 coating rod, with a coating amount of 5.6 g/m², and then placing the paper in an oven for drying at 60° C. for 10 min and then at 120° C. for 2 min to obtain the coated paper.

### Performance Test:

The oil-proof performance of the coated paper of this example was measured. The oil-proof grade kit was measured to be >7. Then, 120° C. edible oil was poured on the coated paper evenly. There was no seepage spot on the surface of the sample, and the oil-proof performance was good. Then, the water-proof performance of the coated paper was measured, and the cobb60 value was 7.1 g/m². The coated paper was able to withstand 95° C. hot water.

The above examples were preferred embodiments of the present disclosure, and the embodiments of the present disclosure are not limited by the above examples. Any other changes, modifications, substitutions, combinations and simplifications made without departing from the spirit and principle of the present disclosure shall be equivalent replacements and are all included in the scope of protection of the present disclosure.

1. A water-proof and oil-proof coating, comprising the following components by mass percent:
10% to 20% of a citrus peel extraction solution;
1% to 2% of bacterial cellulose;
1% to 2% of nano calcium carbonate;
3% to 6% of glycerol;
3% to 5% of a food-grade thickener;
0.2% to 0.6% of a food-grade defoamer;
0.5% to 1% of a food-grade emulsifier; and
the balance being water.

2. The water-proof and oil-proof coating according to claim 1, wherein the citrus peel extraction solution is prepared by a preparation method comprising the following steps:
1) drying, then crushing, and sieving citrus peel to obtain a citrus peel powder; and
2) adding the citrus peel powder to a sodium hypochlorite solution to obtain a mixture, then adjusting a pH value of the mixture to 3-4, then stirring the mixture at a constant temperature of 50° C. to 60° C., then performing an ultrasonic treatment and standing, and collecting a supernatant to obtain the citrus peel extraction solution.

3. The water-proof and oil-proof coating according to claim 2, wherein the citrus peel in step 1) is selected from at least one of orange peel and grapefruit peel.

4. The water-proof and oil-proof coating according to claim 2, wherein the ultrasonic treatment in step 2) has an ultrasonic power of 200 W to 300 W and a treatment time of 10 min to 20 min.

5. The water-proof and oil-proof coating according to claim 1, wherein the bacterial cellulose has a degree of polymerization of 2000 to 4000.

6. The water-proof and oil-proof coating according to claim 1, wherein the nano calcium carbonate has a particle size of 10 nm to 20 nm.

7. The water-proof and oil-proof coating according to claim 1, wherein the food-grade thickener is selected from at least one of xanthan gum, swim bladder gel, and acid-processed gelatin.

8. A method for preparing the water-proof and oil-proof coating according to claim 1, comprising the step of uniformly mixing a citrus peel extraction solution, bacterial cellulose, nano calcium carbonate, glycerol, a food-grade thickener, a food-grade defoamer, a food-grade emulsifier, and water to obtain the water-proof and oil-proof coating.

9. A paper-based material, wherein a surface of the paper-based material is coated with the water-proof and oil-proof coating according to claim 1.

10. A food package comprising the paper-based material according to claim 9.

11. The water-proof and oil-proof coating according to claim 1, wherein the food-grade defoamer is selected from at least one of stearyl stearate, polydimethylsiloxane, and sorbitan fatty acid ester.

12. The water-proof and oil-proof coating according to claim 1, wherein the food-grade emulsifier is selected from at least one of sodium dodecyl sulfate, polysorbate-80, and sorbitan palmitate.

13. The water-proof and oil-proof coating according to claim 2, wherein the drying in step 1) is carried out at 50° C. to 60° C. for a drying time of 40 min to 50 min.

14. The water-proof and oil-proof coating according to claim 2, wherein the sieving in step 1) is performed with a 50-mesh sieve.

15. The food package according to claim 10, wherein the water-proof and oil-proof coating, the paper-based material, or the food package has an oil-proof grade kit >6.

16. The food package according to claim 10, wherein the water-proof and oil-proof coating, the paper-based material, or the food package has a cobb value of water-proof performance of 6.7 g/m² to 8.2 g/m².

17. The method according to claim 8, wherein the mixing is carried out under the condition of a rotation speed of a stirrer of 10000 r/min to 14000 r/min, and a time of the mixing is 10 min to 15 min.

18. The method according to claim 8, wherein the citrus peel extraction solution is prepared by a preparation method comprising the following steps:
1) drying, then crushing, and sieving citrus peel to obtain a citrus peel powder; and
2) adding the citrus peel powder to a sodium hypochlorite solution to obtain a mixture, then adjusting a pH value of the mixture to 3-4, then stirring the mixture at a constant temperature of 50° C. to 60° C., then performing an ultrasonic treatment and standing, and collecting a supernatant to obtain the citrus peel extraction solution.

19. The method according to claim 18, wherein the citrus peel in step 1) is selected from at least one of orange peel and grapefruit peel.

20. The method according to claim 18, wherein the ultrasonic treatment in step 2) has an ultrasonic power of 200 W to 300 W and a treatment time of 10 min to 20 min.
